(19) United States
(12) Patent Application Publication
(10) Pub. No.: US 2015/0304571 A1
(43) Pub. Date: Oct. 22, 2015

(54) AUTOMATED FILMING PROCESS FOR SPORT EVENTS

(71) Applicant: GOLDEN BOY TECHNOLOGY & INNOVATION S.R.L., Milano (IT)

(72) Inventor: Romain SANVITI, Milano (IT)

(73) Assignee: GOLDEN BOY TECHNOLOGY & INNOVATION S.R.L., Milano (IT)

(21) Appl. No.: 14/443,802

(22) PCT Filed: Nov. 26, 2012
(86) PCT No.: PCT/IB2012/056730

§ 371 Date: May 19, 2015

(51) Int. Cl. H04N 5/247; G11B 27/031; H04N 21/2187; H04N 5/77; H04N 21/8549

(52) U.S. Cl. CPC H04N 5/247; H04N 5/77; H04N 21/8549; H04N 21/2187; G11B 27/031

(57) ABSTRACT

Provided is a process for the automated filming of sports events on sports fields using a filming system including a plurality of TV cameras each framing a filming area of the sports field, an electronic data processor connected to the TV cameras, the process including: a filming step including acquiring video recording consisting of a plurality of image frames, from each of said TV cameras and sending each video recording to the electronic data processor, an assessment step, performed by the electronic data processor, wherein each video recording different image frames relating to a same video recording are compared and the degree of change between the different image frames is assessed, and a selection step, performed by the electronic data processor, wherein an edited video recording is obtained by means of the selection, at each given time interval, of one of the video recordings, according to the degree of change.

The present invention relates to a process for the automated filming of sports events of the type as recited in the preamble of Claim 1.

Various systems and processes for the automated filming of sports events are known in the prior art. The term automated means that filming is performed automatically without the need for a cameraman to start, move or operate the TV cameras or for any specific editing involving humans.

Lately, such systems have frequently been used to film amateur and non-professional sports events, when there is a need to reduce costs as much as possible.

For example, systems have been installed at some football fields used mainly to host matches between amateur players, said systems comprising a fixed TV camera which automatically films the entire sports event and, in response to a command sent by a user, saves a last previously defined fixed time interval on a specific digital medium.

In this way, when a goal is scored, or there is a particularly good action on the field, a command can be sent to save the video recording which can then be used and possibly shared online.

The prior art described above has several significant drawbacks.

Recordings done in this way are laborious to obtain and, secondly, cannot be edited.

To overcome this drawback, video recordings can be acquired by several TV cameras and then sent to users via the web or using other means of communication.

However, such transmission is extremely laborious and requires a very fast data transmission speed, given the huge amount of data contained in the plurality of video recordings.

In this situation the technical purpose of the present invention is to develop a process for the automated filming of sports events able to substantially overcome the inconveniences mentioned above.

Within the sphere of said technical purpose, one important aim of the invention is to obtain a process for the automated filming of sports events whereby video recordings can be watched immediately and which is capable of filming substantially only the action on the field.

Another important aim of the invention is to conceive a process for the automated filming of sports events which produces video recordings that can be transferred rapidly via the web.

The technical purpose and specified aims are achieved with a process for the automated filming of sports events as claimed in the appended claim 1. Preferred embodiments are described in the dependent claims.

The characteristics and advantages of the invention are clearly evident from the following detailed description of a preferred embodiment thereof, with reference to the accompanying drawings, in which:

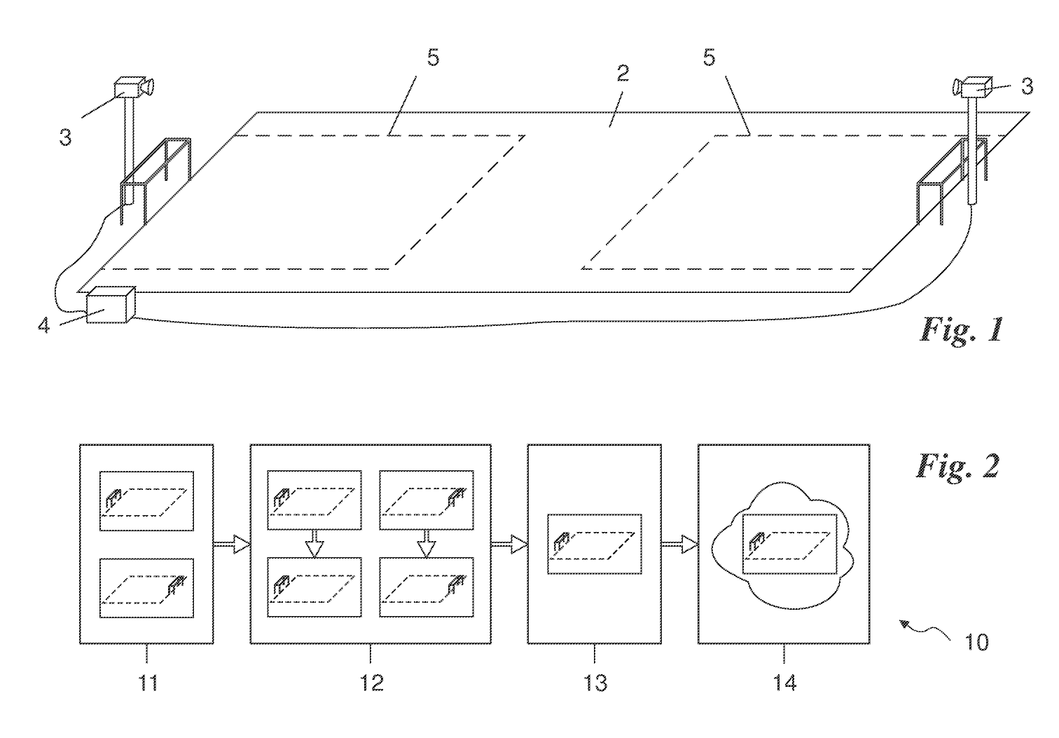

FIG. 1 schematically illustrates a system for the automated filming of sports events according to the invention; and

FIG. 2 schematically illustrates a process for the automated filming of sports events according to the invention.

With reference to said drawings, reference numeral 10 globally denotes the process for the automated filming of sports events.

The process 10 is suitable for filming games played on a spatially delimited sports field 2, for example ball games and similar games. A preferred application of said process is the game of football but said process 10 may also be used for many other games instead, such as: basketball, tennis, rugby and many other games.

The filming process 10 is implemented by means of an automated filming system 1, the structure of which is described below.

It comprises, in brief: a plurality of TV cameras 3, each one suitable to frame a filming area 5 of the sports field 2, an electronic data processor 4 or computer, connected to the TV cameras 3, and connected to end users preferably via the web or internet.

In detail, there are preferably two TV cameras 3, each of which appropriately suitable to produce high-definition video recordings, in particular in full HD. Each TV camera 3 is preferably arranged at one end of the sports field 2 and in a raised position, so as to be able to frame a wide filming area 5 without any perspective distortion. In particular, if there are two TV cameras 3 and the sports field is rectangular, said TV cameras 3 are arranged on the outside of the sports field 2 at the point halfway along the short sides of said field, and at a height of between 1.5 metres and 3 metres with respect to the ground on which the field is marked out.

The TV cameras 3 are preferably connected to the electronic data processor 4 by means of known wired or wireless connections. Said connections are also preferably dedicated, and do not overload other communication channels such as web channels. The data processor 4 is therefore appropriately in proximity to the TV cameras 3, in particular in the same group of buildings and sports complex or the like.

According to an alternative embodiment, said TV cameras are connected to the electronic data processor 4 via the web.

The electronic data processor 4 preferably consists of a server computer of a type known in the prior art, and is also appropriately connected to the end users via the web or, alternatively, via television communication protocols or other. The process 10, implemented by means of the device 1, is described below.

It comprises, in brief, a filming step 11, in which each TV camera 3 acquires a video recording and sends it to the electronic data processor 4, an assessment step 12, performed by the electronic data processor 4, in which the changes within each single video recording are assessed, a selection step 13, in which one single video recording is selected, and a transmission step 14, in which the video recording is transmitted to the end users.

In detail, in the filming step 11 each TV camera 3 acquires a video recording of at least the fixed filming area 5 and part of the sports field 2. The TV camera 3 is thus also fixed.

The filming area 5 can be selected by the user according to the type of sports field and game. In particular it consists of a main portion of one half of the sports field 2, more in particular of the portion of the half of the field closest to the area in which the points are scored, for example in proximity to the goal and the penalty area in the case of football, in proximity to the basket in the case of basketball, and so on. The filming area 5 is preferably rectangular. Moreover the filming area 5 is preferably at a distance from the relative TV camera 3 such that the ratio between the distance of the point of the filming area 5 furthest away from the TV camera 3 and that of the filming point closest to the TV camera 3, is less than 4 and more preferably less than 2.5. In that way the perspective does not excessively distort the proportions of the players on the sports field and can be ignored during the assessment step 12.

During the filming step 11 high definition video recordings are obtained, preferably in the full HD format corresponding to 1920×1080 pixels. The video recordings clearly comprise a plurality of image frames, in particular 18 to 32 image frames per second, more in particular 24.

The video recordings, from each TV camera, are sent to the electronic data processor 4 via the specific dedicated connections, in particular via cabled connections or, alternatively, wireless connections.

The electronic data processor 4 performs the subsequent assessment step 12. In said assessment step 12 each video recording is assessed individually. In particular, different image frames relating to a same video recording are compared and the degree of change between the different image frames is assessed.

Said degree of change is determined by assessing the difference in colour of the individual corresponding pixels, belonging to said different image frames. Alternatively, other change-related parameters, such as changes in the position of people, or other changes, can be measured. Said change is, for example, assessed by means of software programs suitable to perform conventional motion detection, for example using the software library known as Aforge in the Microsoft .NET environment, while the image frames are acquired with Milestone libraries, preferably in the same environment.

In particular, the change in subsequent image frames is assessed and more in particular in adjacent image frames. Moreover, advantageously, not every pair of adjacent image frames is assessed, but the assessment step 12 is only performed at each comparison period.

In particular, the comparison period is comprised between 6 and 18 image frames, more in particular between 10 and 14 image frames and yet more in particular every 12 image frames. Consequently the 12^{th} image frame is compared with the 11^{th} and the 24^{th} with the 23^{rd}.

The comparison period is thus comprised between 0.1 seconds and 1 second and approximately close to 0.5 seconds.

Moreover the different assessment steps 12 performed on different video recordings are performed on image frames acquired substantially simultaneously.

From the assessment a scale emerges on which the changes are rated on a scale from 0, which corresponds to a change of 0%, i.e. substantially no change between image frames, to 1, which corresponds to a change of 100%, i.e. total change of the pixels in the two image frames being compared.

The subsequent selection step 13 is also performed by the electronic data processor 4, which consequently produces an edited video recording, obtained by automatically selecting at each time interval one of said video recordings, according to the degree of change, as described below.

Said time intervals appropriately correspond to the comparison periods described previously.

The next selection step 13 of the specific video recording is preferably performed by selecting the video recording with the greatest degree of change. In particular in the selection step a new video recording is selected, instead of the one that has currently been selected, only if said degree of change of said new video recording, with respect to said currently selected video recording, exceeds a given threshold. Otherwise the data processor 4 continues to select the current video recording. Said solution avoids continuous changes of shot at times when play is slack. Said change threshold corresponds to a degree of change comprised between 0.00001 and 0.01, which corresponds to a percentage of pixels changed in colour comprised between 0.001% and 1%. Said threshold can also be selected by the owner of the system.

Lastly, in the transmission step 14 the edited video recording is transmitted preferably via web to the end users.

In particular, the edited video recording is stored on a specific web space, such as a website or part of a known website. The end users can thus access said web space to watch the video recording and possibly share it with other users. In particular said web space contains some functions, of a type known in the prior art, whereby it is possible to select a temporal portion of the video recording and share it on social networks with other users. For example goals and points scored or spectacular actions can be shared.

The use of the system 1, described in detail in functional terms, is as follows: The system is installed by positioning the TV cameras 3 on specific supports, arranging the electronic data processor 4 in proximity to the TV cameras 3, and connecting the TV cameras 3, at one or more sports fields, to the electronic data processor 4.

Next the various software parameters are defined, in particular the filming areas 5, the change threshold and, where applicable, the comparison period. Said parameters are configured according to the game and the dimensions and type of sports field.

The matches are thus filmed automatically and the edited video recordings that are obtained are automatically controlled.

The end users can thus also watch the edited video recordings, on demand but also live, and share various actions on social networks, or simply watch the match again.

The invention achieves some important advantages.

The system 1 and process described permit the creation of video recordings that are edited automatically, thus considerably reducing the costs involved. Moreover, said steps of assessment 12 and of selection 13, preferably implemented by a specific software program, allow the end user to watch, and thus to download from the web, a single edited video recording and not a plurality of video recordings that would overload the user's internet connection. Said advantage is also obtained by the system manager if the TV cameras 3 are connected to the electronic data processor 4 by means of dedicated connections. In that case, the manager also only needs to transmit a single edited video recording rather than a plurality of video recordings for each sports field, which would require a faster connection.

Moreover, thanks to the processes described, there is no substantial loss of information with the edited video recording in relation to the plurality of video recordings. Furthermore. the selection of the comparison period and of the processes described avoids overloading the electronic data processor 4 with too many pointless calculations.

Modifications and variations may be made to the invention described herein without departing from the scope of the present invention. All details may be replaced with equivalent elements and the scope of the invention includes all other materials, shapes and dimensions.

1. A process for the automated filming of sports events on sports fields using a filming system, comprising a plurality of TV cameras each framing at least one filming area of said sports field, an electronic data processor connected to said TV cameras, said process comprising:
a filming step comprising acquiring a video recording consisting of a plurality of image frames, from each of said TV cameras and sending each video recording to said electronic data processor, and wherein comprises:
an assessment step, performed by said electronic data processor, wherein, for each of said video recordings, different image frames relating to a same video recording are compared and the degree of change between said different image frames is assessed, and
a selection step, performed by said electronic data processor, wherein an edited video recording is obtained by means of the selection, at each given time interval, of one of said video recordings, according to said degree of change.

2. The process as claimed in claim 1, wherein said degree of change is determined by assessing the difference in the colour of the corresponding individual pixels, belonging to said different image frames.

3. The process as claimed in claim 1, wherein different assessment steps performed on different video recordings are performed on image frames acquired substantially simultaneously.

4. The process according to claim 1, wherein in the assessment step, for each of said video recordings, adjacent image frames are compared.

5. The process as claimed in claim 1, wherein said assessment step is performed at each comparison period and wherein said comparison period is comprised between 6 and 18 image frames.

6. The process as claimed in claim 5, wherein said comparison period is comprised between 10 and 14 image frames.

7. The process as claimed in claim 1, wherein in said selection step, one of said video recordings with the greatest said degree of change is selected.

8. The process as claimed in claim 1, wherein in said selection step, a new video recording is selected, instead of the one that has currently been selected, only if said degree of change of said new video recording, with respect to said currently selected video recording, exceeds a change threshold.

9. The process as claimed in claim 8, wherein said change threshold corresponds to a percentage of pixels changed in colour comprised between 0.001% and 1%.

10. The process as claimed in claim 1, wherein said electronic data processor is arranged in proximity to said TV cameras and connected thereto by means of dedicated connections, and wherein the process comprises a transmission step in which said edited video recording is transmitted via a web space.
